(19) United States
(12) Patent Application Publication
(10) Pub. No.: US 2007/0085498 A1
(43) Pub. Date: Apr. 19, 2007

(54) Method and apparatus to control a variable speed motor

(75) Inventors: Vivek Kulkarni, Hyderabad (IN); Kamron Mark Wright, Ft. Wayne, IN (US); Brian L. Beifus, Ft. Wayne, IN (US); Roger C. Becerra, Ft. Wayne, IN (US); William A. Archer, Ft. Wayne, IN (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Regal-Beloit Corporation

(21) Appl. No.: 11/252,298

(22) Filed: Oct. 17, 2005

(51) Int. Cl. H02P 7/06

(52) U.S. Cl. 318/254; 318/471

(57) ABSTRACT

A thermostat transducer module includes a processor, at least one A/D conversion circuit interfaced to the processor, and at least one output level conversion circuit interfaced to the processor. The processor is configured to receive signals originating at a thermostat through the at least one A/D conversion circuit, analyze the received signals and generate signals based on the analysis for output through the at least one output level conversion circuit for control of a motor.

### BACKGROUND OF THE INVENTION

This invention relates generally to control of electronically controlled motors, and more specifically to a system remote from the motor and capable of processing system control signals, for example, originating from a thermostat system to control operation of the motor.

At least some known electronically commutated motors (ECMs) incorporate a controller within a chassis of the motor which is capable of interfacing with system control signals, such as from a thermostat. These internal controllers are typically microprocessor based and programmable with certain desired operating characteristics. However, adding such a controller to a motor adds significant cost to the motor. In addition, a failure of either the motor or the controller requires that both be replaced. Also since ECMs are used in applications other than thermostat controller applications, additional motor models have to be supplied to service those non-thermostat based applications.

Some ECMs are configured with one or more of serial communications capabilities and a pulse width modulated (PWM) input to provide an interface to an external system. However, signals from thermostat based systems are based on a 24 VAC voltage supply. Typically the serial/PWM interfaces of these ECMs are not capable of interfacing directly with signals based on a 24 VAC voltage supply. As such there is no simple and low cost interface between the serial communication and/or PWM signal interface of the ECM and the 24 VAC based thermostat signal lines and thermostat signals are not currently configurable into ECM compatible serial and PWM signals that are operable to control operation of such a motor.

### BRIEF DESCRIPTION OF THE INVENTION

In one aspect, a thermostat transducer module is provided that comprises a processor, at least one A/D conversion circuit interfaced to the processor, and at least one output level conversion circuit interfaced to the processor. The processor is configured to receive signals originating at a thermostat through the at least one A/D conversion circuit, analyze the received signals and to generate signals based on the analysis for output through the at least one output level conversion circuit for control of a motor.

In another aspect, a variable speed motor control system is provided that comprises a motor configured to receive motor control signals, a thermostat configured to output at least one system control signal, and a thermostat transducer module comprising a processor, at least one A/D conversion circuit interfaced to the processor, and at least one output level conversion circuit interfaced to the processor. The thermostat transducer module is configured to receive signals originating at the thermostat through the at least one A/D conversion circuit and further configured to utilize the received signals to generate signals for output through the at least one output level conversion circuit to provide motor control signals to the motor.

In still another aspect, a method for controlling a motor is provided. The method comprises receiving signals from a thermostat, interpreting the signals from the thermostat with a processor, and outputting signals from the processor to control the motor, the signals from the processor based at least in part on the signals from the thermostat.

### BRIEF DESCRIPTION OF THE DRAWINGS

FIG. 1 is a block diagram of a motor control system including a thermostat transducer module.

FIG. 2 is a block diagram of the thermostat transducer module shown in FIG. 1.

FIG. 3 is a flow chart of a program that can be executed within the thermostat transducer module of FIG. 2.

FIG. 4 is a schematic diagram of a microcontroller including peripheral components associated with operation of the microcontroller.

FIG. 5 is a schematic diagram of a power supply that can be utilized in a thermostat transducer module.

FIGS. 6A, 6B, and 6C are schematic diagrams of circuits utilized to form analog to digital converters that are used to convert thermostat signals to digitally compatible signals.

FIG. 7 is a schematic diagram for an output signal amplifier.

FIG. 8 is a schematic diagram illustrating an inverting amplifier configured to output either pulsed revolutions per minute (RPM) signals and/or a pulse width modulated signal.

FIG. 9 is a schematic diagram 300 illustrating signals input to DIP switches and an eight pin connector for on board microcontroller memory programming.

### DETAILED DESCRIPTION OF THE INVENTION

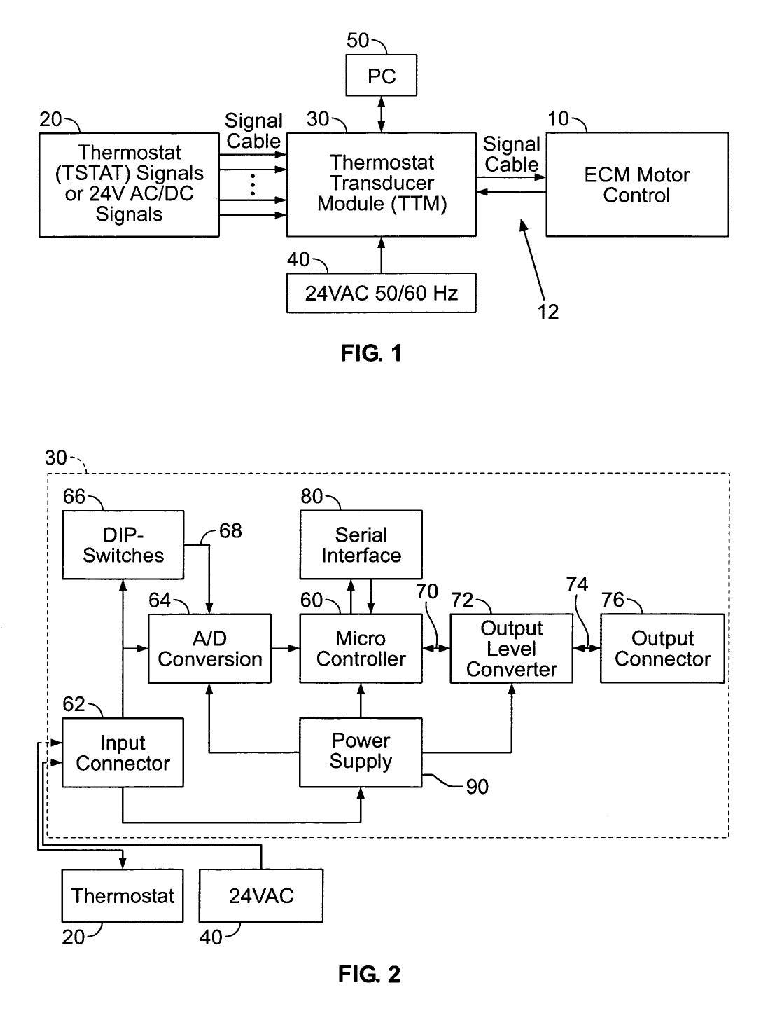

Referring to FIG. 1, an electronically commutated motor (ECM) 10 is typically configured with one or more of a serial communications capability and a pulse width modulated (PWM) input for communications with external systems. The serial communications capability and PWM input are illustrated in FIG. 1 as signal cables 12. Now referring to thermostat 20, most thermostat signals 22 are based on a 24 VAC power supply. Typically ECMs, for example, ECM 10 are not configured to directly interface with 24 VAC based signals. Accordingly, an intermediate system, such as a thermostat transducer module 30 configured to convert 24 VAC thermostat signals into ECM compatible PWM signals and/or serial communication signals, is utilized. In the embodiment illustrated, thermostat transducer module 30 is configured to utilize a 24 VAC power source 40, and further configured to communicate with a computer 50.

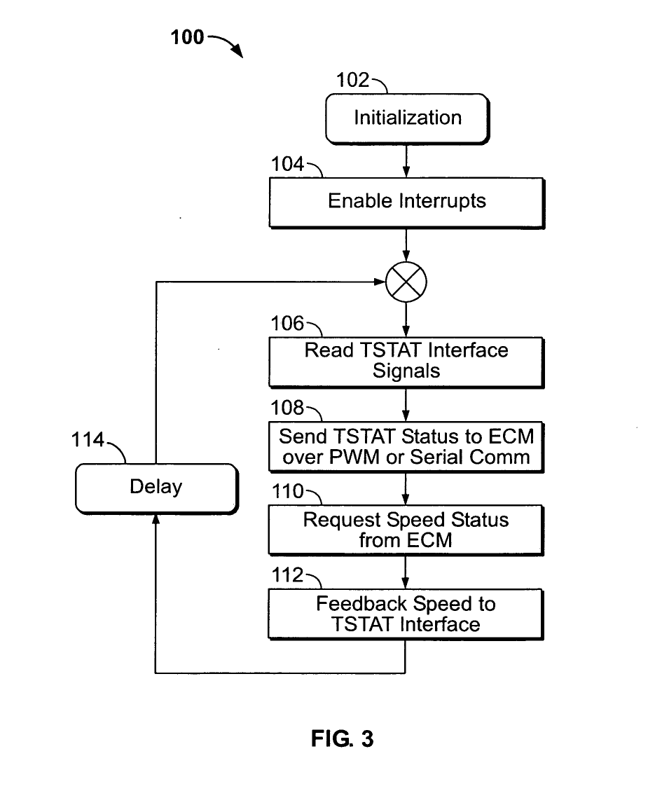

FIG. 2 is a block diagram of one embodiment of thermostat transducer module 30. Thermostat transducer module 30 is configured to convert 24 VAC signals, rectified AC signals, and DC signals received from thermostat 20 into PWM signals and/or serial communications signals to interface with ECM 10 (shown in FIG. 1). The signals from thermostat 20 are translated to digital signals by electronics within thermostat transducer module 30 and interfaced to microcontroller 60. For example, signals input into thermostat transducer module 30 from thermostat 20 are passed through an input connector 62 to one of an A/D conversion circuit 64 or through a dual inline package (DIP) switch 66 whose output 68 is input into A/D conversion circuit 64. Signals from A/D conversion circuit 64 are provided to microcontroller 60.

Microcontroller 60 processes the converted signals and outputs one or more of PWM signals and serial communication signals to ECM 10. More specifically, signals 70 from microcontroller 60 are output to an output level converter 72 and signals 74 from output level converter 72 are passed through an output connector 76 which is coupled to ECM 10. Microcontroller 60 is programmable and a serial interface 80 provides an interface to external systems, for example, computer 50 (shown in FIG. 1) for the reprogramming of microcontroller 60, if desired, along with motor operating parameters that can be monitored and or warehoused within computer 50.

In one embodiment, thermostat transducer module 30 is programmed to provide a PWM signal to ECM 10. An example frequency for the PWM signal is about 100 Hz. The PWM signals include a defined pulse width, slew rate, and off delay depending on the signal provided to thermostat transducer module 30 by thermostat 20 and depending on a position of the switches within DIP switch 66.

Revolutions per minute (RPM) information is fed back from ECM 10 and upon conversion by thermostat transducer module 30 to a short pulse digital signal of frequency equivalent to RPM is output via serial interface 80. Microcontroller 60 is configurable to perform many functions with regard to operation of ECM 10 including, but not limited to, the reading of digitized signals from thermostat 20, communication of the digitized signals to ECM 10 with at least one of serial communications and PWM at a programmed slew rate of PWM change.

Microcontroller 60 is further configurable to read an RPM from ECM 10 and communicate the RPMs back to other system interfaces (e.g. serial interface 80). After performing these actions, microcontroller 60 sends a response back to the other systems, for example, through serial interface 80. The response includes RPM information that might be useful, for example, to display motor RPM. Pulsed RPM information is generated by thermostat transducer module 30 in one embodiment. Thermostat transducer module 30 further communicates with a control unit (not shown), which includes the serial communications and/or PWM interface for ECM 10, in one embodiment through a four channel cable. One end of the cable has a connector configured to engage output connector 76 to connect the cable to thermostat transducer module 30. An opposite end of the cable includes a connector configurable to engage a connector on the ECM's motor control unit. As appreciated by those skilled in the art, microcontroller 60 communicates with the motor control unit of ECM 10 through this cable and the motor control unit sends its responses to microcontroller 60 through the same cable. Components of thermostat transducer module 30 are powered via a power supply 90 which operates from one or more of a 24 VAC, 50/60 Hz source, a rectified 24 VAC source, and a 24 VDC source.

Thermostat transducer module 30 provides low cost, serial communications and PWM interfaces between ECM 10 and signals from thermostat 20. Thermostat transducer module 30 achieves this low cost through utilization of a low cost microcontroller (e.g., microcontroller 60) to facilitate serial communication. In addition, thermostat transducer module 30 includes simple electronic interfaces for the conversion of analog thermostat signals to digital signals which can be interpreted by microcontroller 60.

In addition, thermostat transducer module 30 simplifies the hardware interface (e.g., allows for easier digitization and serial communications of signals to and from thermostat 20 and ECM 10) since there are a reduced number of connections to other systems. Standard connectors and surface mount devices are used in thermostat transducer module 30. As well microcontroller 60 and thermostat transducer module 30 are upgradeable through a reprogrammable interface. In one embodiment, microcontroller 60 includes a flash memory which is reprogrammable through serial communications port 80 and compatible with serial communication ports (e.g., RS-232 and RS-485) available on almost every computer (e.g., computer 50). This flash memory allows for easy addition of new features to thermostat transducer module 30. In an alternative embodiment, thermostat transducer module 30 is configured with extra input and output signals which provide for future functional additions, for example, an LED display to provide user feedback and troubleshooting feedback.

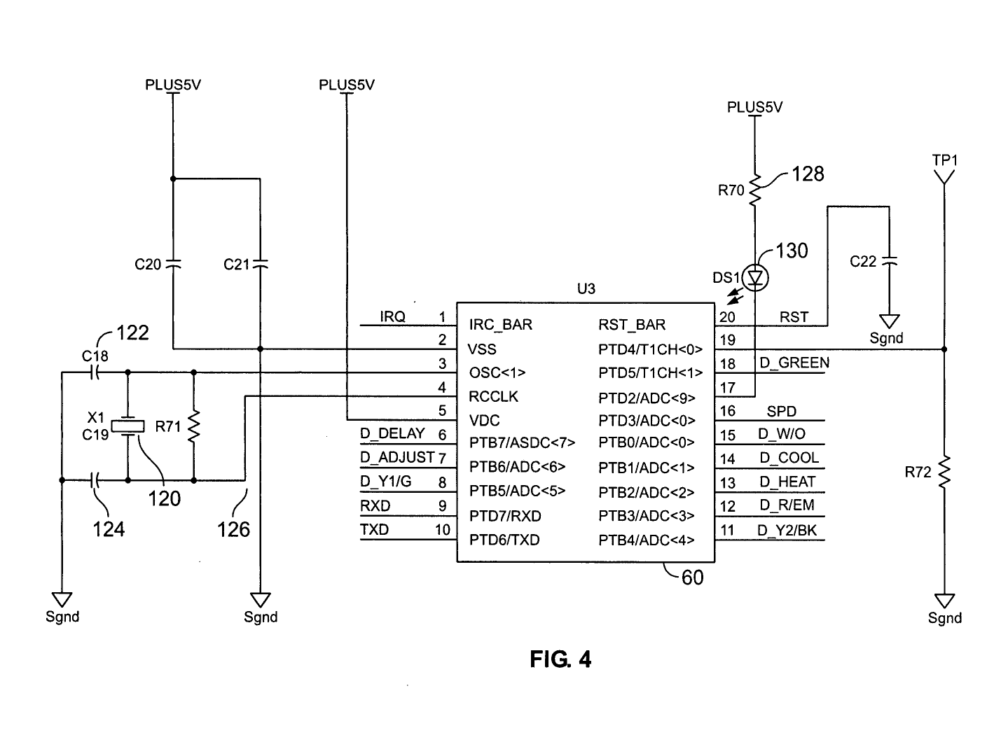

FIG. 3 is an example program flow chart 100 that may be programmed into microcontroller 60 of thermostat transducer module 30 (both shown in FIG. 2). Thermostat transducer module 30 is initialized 102 as power is applied. After initialization 102, microcontroller 60 is programmed to enable 104 interrupts. Thermostat transducer module 30 then reads 106 interface signals from thermostat 20 and a status of thermostat 20 is sent 108 by microcontroller 60 to ECM 10 using one or both of a pulse width modulated signal and a serial communications interface. Microcontroller 60 then requests 110 ECM motor RPM data over serial communication lines and the motor speed response is communicated 112 to other system interfaces, for example, computer 50 and thermostat 20. In one embodiment, RPM data is communicated over differential lines referred to as RPM (+) and RPM (−). After a delay 114, the process begins again at step 106.

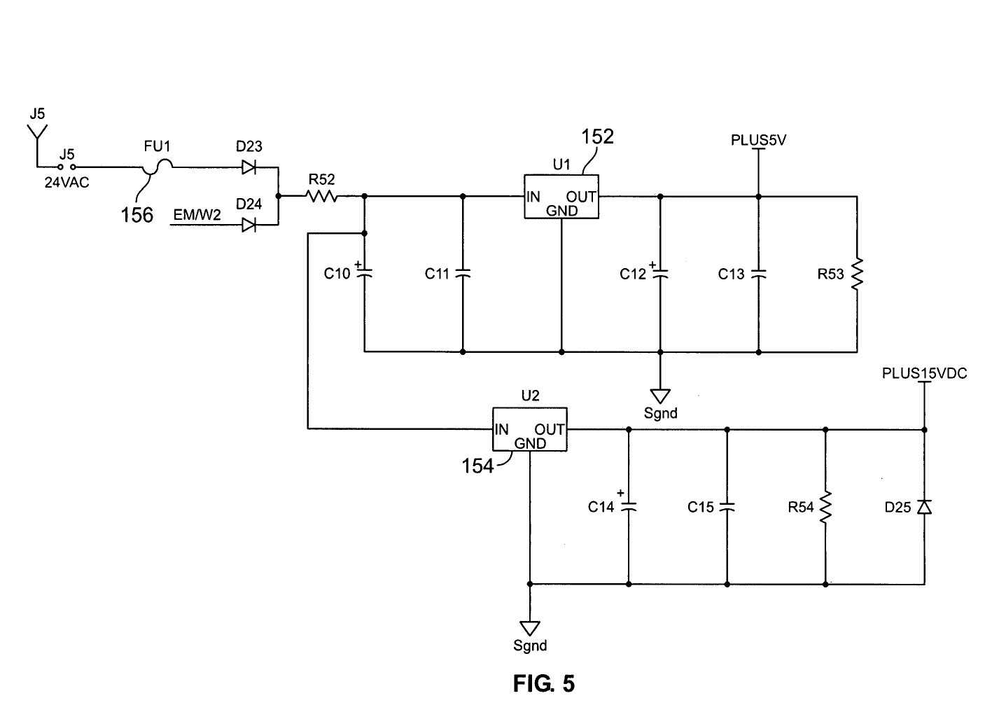

FIGS. 4-9 are schematic diagrams relating to particular portions of thermostat transducer module 30. The schematic diagrams illustrate exemplary embodiments, and those skilled in the art will realize that alternative circuits to those illustrated in the schematics may be utilized. As previously described, microcontroller 60 is configured to read inputs from thermostat 20 through an analog to digital converter sub-circuit (A/D converter 64) and process the input signals using program code running within microcontroller 60. Microcontroller 60 also communicates PWM signals and serial communication signals to ECM 10. In an exemplary embodiment, and referring to FIG. 4, microcontroller 60 is a Motorola MC68HC908JK8 microcontroller and includes onboard flash memory, which is easily erasable and programmable. The onboard flash memory allows microcontroller 60 to be in circuit programmed through a host PC (e.g., computer 50 (shown in FIG. 1)) and therefore eliminates a need for external ROM. The combination of being easily programmable in circuit and the availability of 14 input/output pins on microcontroller 60 allows for easy upgrading and expansion. In the embodiment, a crystal oscillator 120 is included that defines the operating speed of microcontroller 60. Capacitors 122, and 124 are used for noise filtering and a resistor 126 is configured as a discharge resistor.

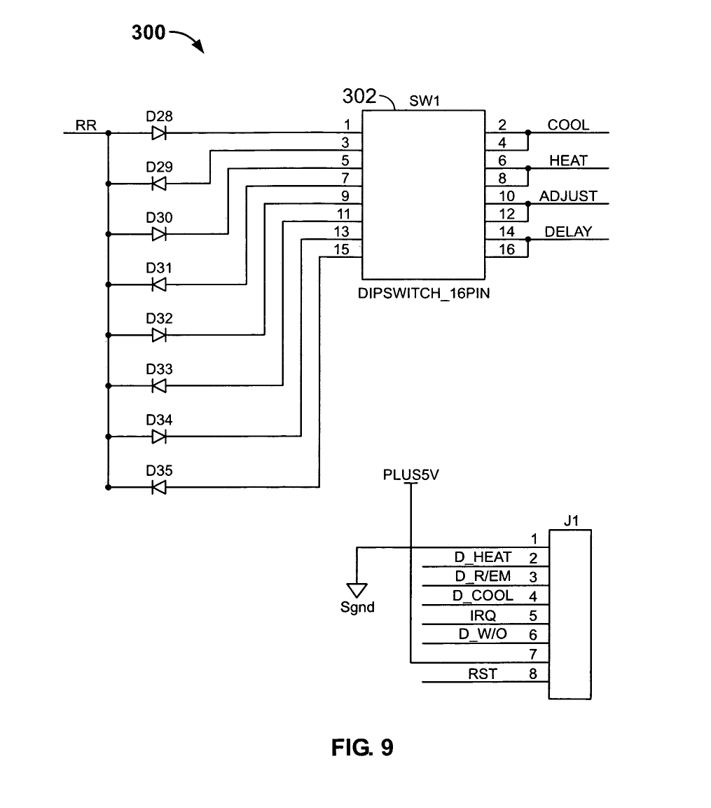

A resistor 128 and LED 130 are utilized for indicating that microcontroller 60 is operating normally. Pins 1, 12, 13, 14, 15 and 20 of microcontroller 60 are used for reprogramming the microcontroller flash memory. In one embodiment, programming is accomplished through an eight pin connector (shown in FIG. 9) with one of the pins of the connector connected to ground and another of the pins connected to +5 VDC. In the embodiment, pins 12 and 13 of microcontroller 60 are connected to ground and pin 14 is connected to +5 VDC during re-programming of the flash memory. While described herein as a microcontroller, those of ordinary skill will appreciate that the functions of microcontroller 60 can be performed by a microprocessor, a programmable logic device, a programmable gate array, or any other programmable device or processor capable of performing the functions described herein.

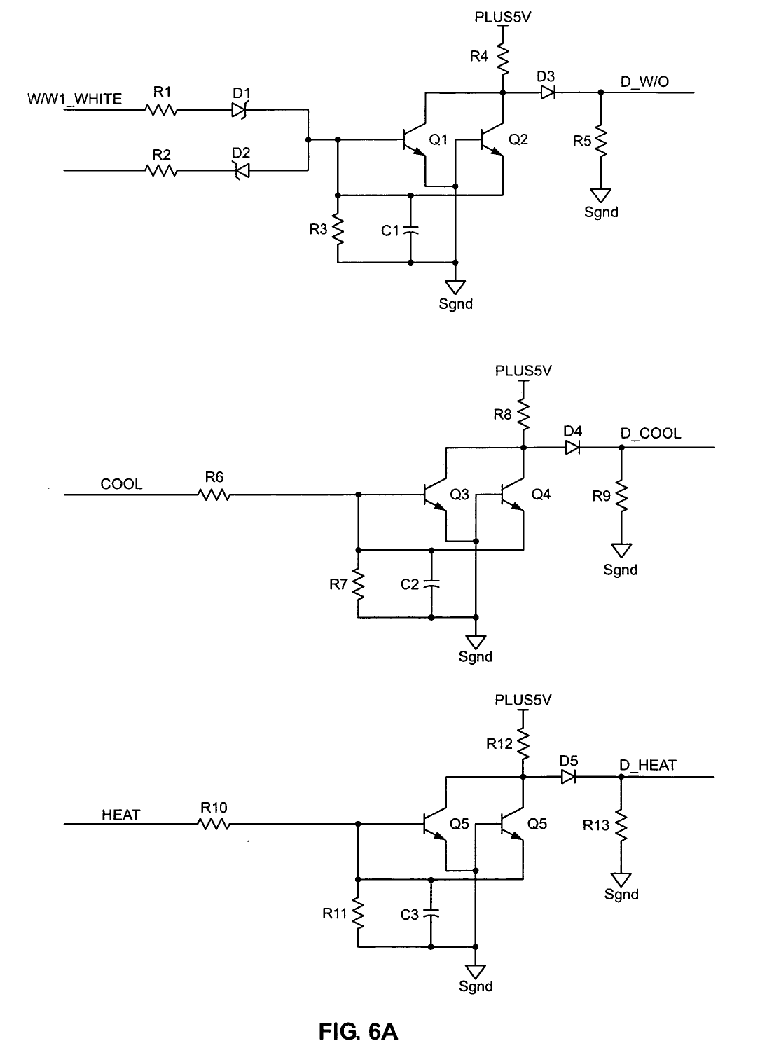

FIG. 5 is a schematic diagram 150 of one embodiment of a power supply that can be utilized in thermostat transducer module 30. More specifically, power supply circuit components D23, D24, D25, C10 through C15, R52, R53, R54, U1 & U2 form a DC power supply. The power supply is used to convert a 24 VAC source voltage into onboard power supplies required for the circuits and microcontroller 60 of thermostat transducer module 30. The power supply circuit incorporates fixed positive regulators 152 and 154 to produce regulated +5 VDC voltage and regulated +15 VDC voltage respectively. R52 performs inrush current protection for the power supply and a re-settable fuse 156 is utilized for over current protection.

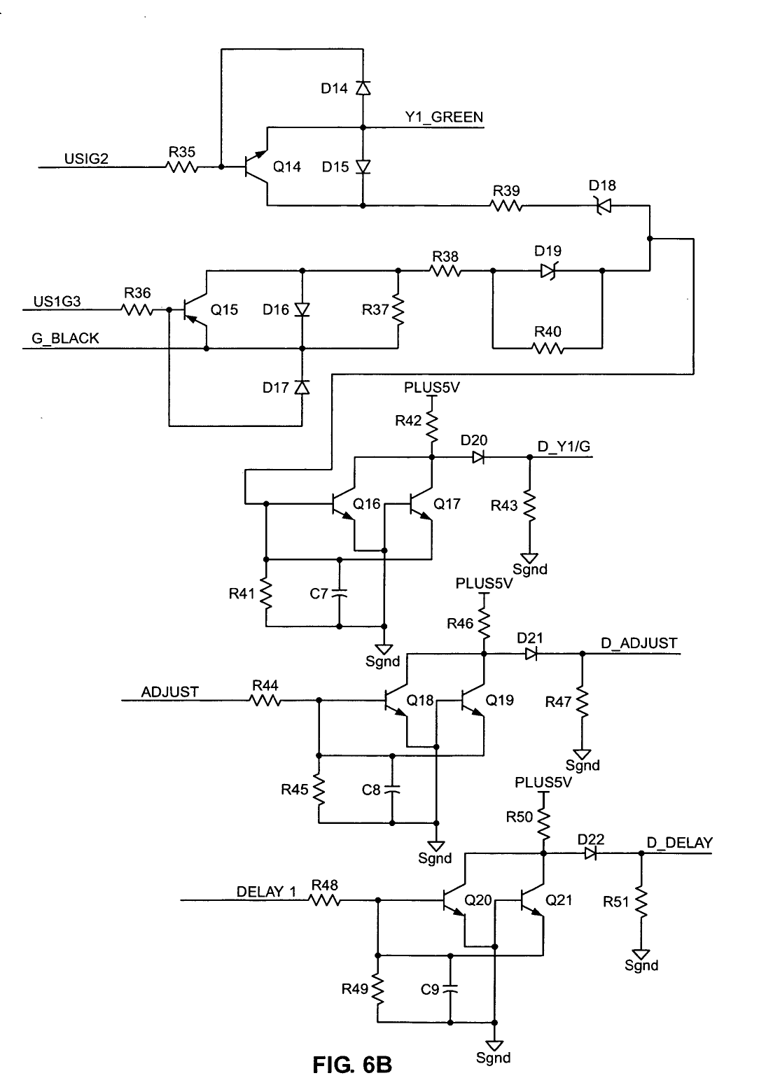

Referring to FIGS. 6A, 6B, and 6C, thermostat transducer module signals include, but are not limited to, W/W1, COOL, HEAT, Y1, G, ADJUST, DELAY, C2, R/EM, Y/Y2, BK/PWM, and Y1, which are standard motor control and thermostat signals. In one embodiment, each of these signals is either 24 VAC (±10%) or positive rectified 24 VAC or negative rectified 24 VAC or DC signals. FIG. 6 includes a schematic of the sub circuits associated with each of the above listed signals. Specifically, the sub-circuits shown form analog to digital converters (ADCs) and are used to convert thermostat signals to digitally compatible signals (<0.5 VDC and >4 VDC) that can be input to microcontroller 60. Each sub circuit provides rectification and voltage limiting. For example, for a full wave AC input signal, the appropriate sub-circuit outputs a short duration pulse at every zero voltage crossing. For a half wave AC input signal, the appropriate sub-circuits output a nearly square wave pulse of inverted polarity. The diodes in these sub circuits perform rectification as well as electrostatic discharge protection for the other electronics within these sub-circuits.

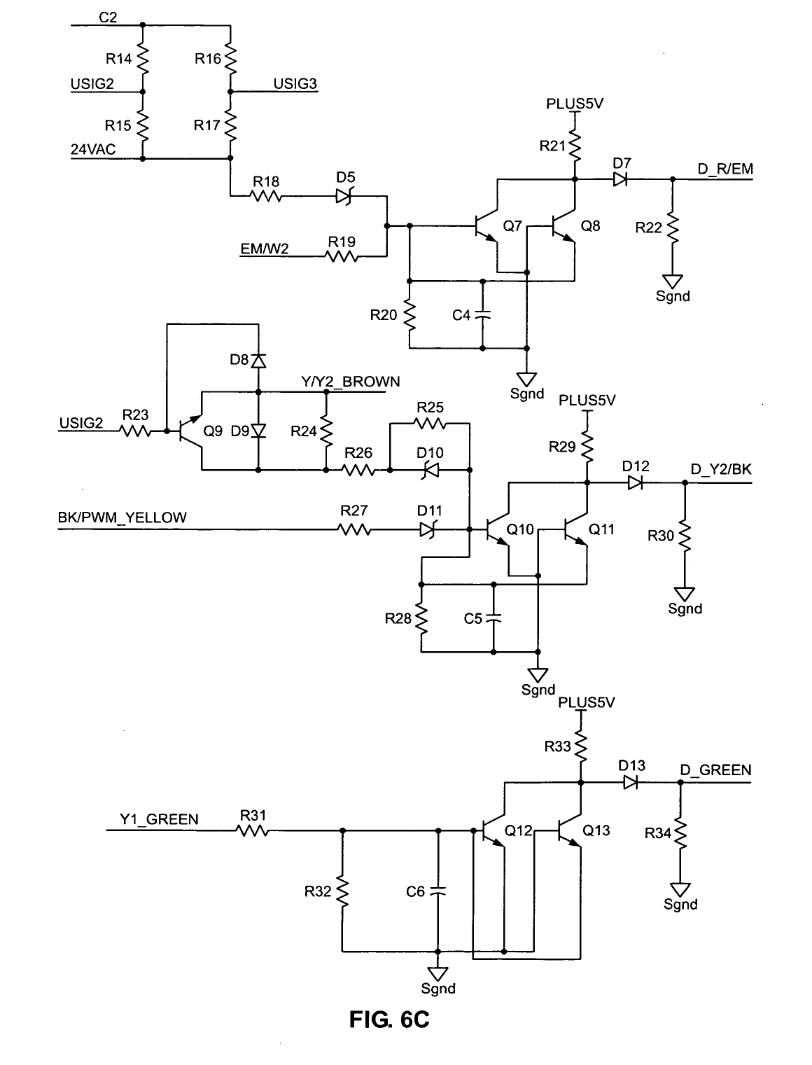

Now referring to FIG. 7, a schematic diagram 200 for an output signal amplifier, or level converter circuit is shown. Resistors R63 through R66, transistors Q24 and Q25, and diode D26 form the amplifier. In one embodiment, this circuit is utilized to convert a serial communication signal, a pulse width modulated signal, or a DC signal from microcontroller 60 to an equivalent or amplified 15 VDC level signal. Diode D26 provides transient protection for the signal output. LED DS3, and resistors R67 and R68 provide an LED indication for an RPM feedback signal from the electronically commutated motor (ECM). R69 and R73 are respectively a current limiting resistor and pull-up resistor for a serial communications path (RXD) that may be utilized for pulse width modulation. Diode D27 provides transient protection for the serial communications output signal RXD.

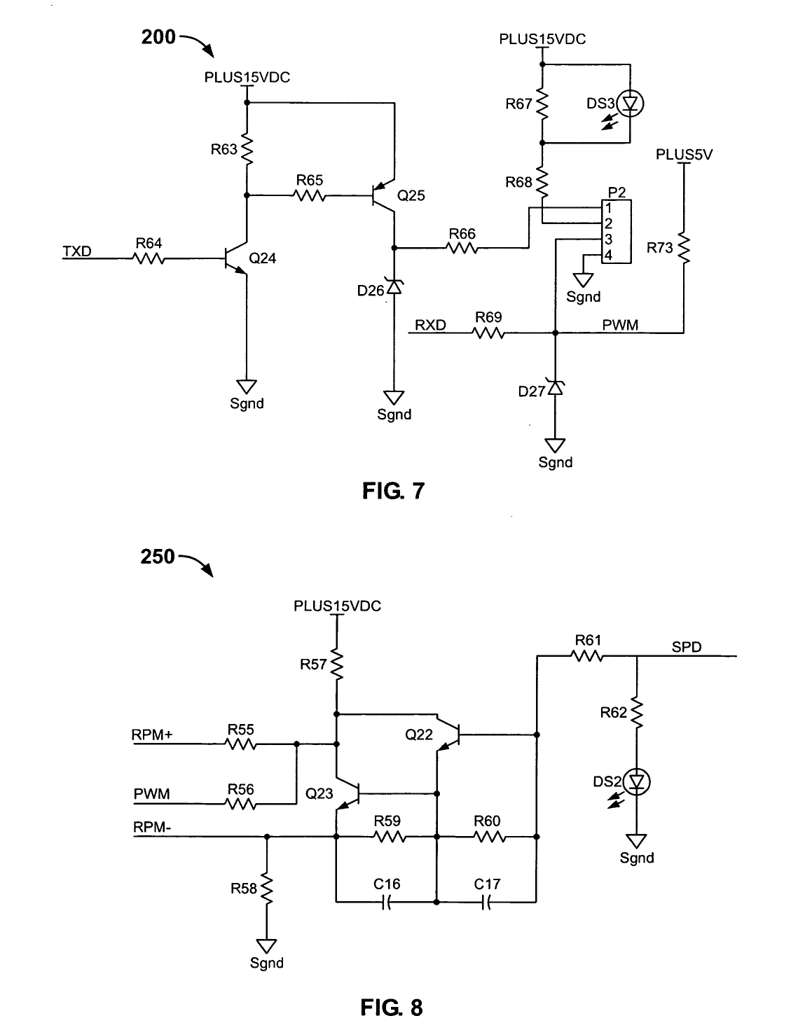

FIG. 8 is a schematic diagram 250 illustrating an inverting amplifier configured to output either pulsed RPM signals and/or a pulse width modulated signal generated by microcontroller 60. Circuit components include resistors R55 through R61 and R73, capacitors C16 and C17, transistors Q22 and Q23, and light emitting diode DS2. The amplifier circuit converts voltage levels from 5 VDC to 15 VDC. LED DS2 and resistor R62 are utilized to indicate the RPM pulsed output from microcontroller 60.

FIG. 9 is a schematic diagram 300 illustrating signals input to a DIP switch 302 that, in one embodiment and in conjunction with diodes D28 through D35 are utilized for Tap select on 24 VAC signals. Outputs of DIP switch 302 form inputs to certain of the analog to digital converter circuits illustrated in FIG. 6. Inputs to the individual switches are derived from a 24 VAC signal, which is a thermostat interface signal. Tap select, as used herein, refers to on board selection of particular thermostat signals, for example, COOL, HEAT, ADJUST, DELAY, or similar signals that are generated utilizing the above described microcontroller based circuit. The signals are generated using the DIP switches, when such signals are not available at the external interface to thermostat transducer module 30.

The tap select are utilized as inputs and are configured, based on the programming of microcontroller 60, to influence operation of thermostat transducer module 30 to adapt to local conditions at the end use installation. In one embodiment, both full and half wave AC signals may be connected to tap inputs, which results in an ability to concentrate up to four discrete electrical states onto one input wire. such a configuration helps to minimize the number of input lines required into thermostat transducer module 30. These tap inputs therefore operate as option selection inputs that can be controlled by either of an onboard DIP switch or by external switches if the DIP switches are left in the open position.

The embodiments described herein provide a system, which is capable of processing any system control signal, for example, a temperature control signal from a thermostat system. Upon processing of the thermostat control signal, the system (thermostat transducer module 30) is configured to output a serial communication signal and/or pulse width modulated signal to control operation of an electronically commutated motor (ECM). As most ECMs are configured with serial communications and/or PWM input capabilities, and most thermostat signals are based on 24 VAC signals, these ECMs cannot directly interface with the thermostat signals. Thermostat transducer module 30 provides an intermediate system for converting thermostat signals into PWM signals, including programmable slew rates, and/or serial communication signals. In addition, since thermostat transducer module 30 is microcontroller based, a user is able to easily expand the programming of microcontroller 60 to add new features to thermostat transducer module 30, including, but not limited to, motor operation feedback such as RPM, furnace control, memory check, and opto check, which generally refers to a test of the operability of opto-couplers in the motor control unit).

The above described embodiments, result in a thermostat transducer module 30 having one or more input and output signal lines that are controlled by a switch closure to a 24 VAC source. The signals present on the input lines result in an input combination. Microcontroller 60 is programmed to determine, using rules incorporated into the microcontroller program, an operating level for a motor based on the input combination. Microcontroller 60 is, in one embodiment, further programmed to determine an on/off threshold in the case where a switch has a resistance in parallel with it, as is the case with some thermostat lines.

While the invention has been described in terms of various specific embodiments, those skilled in the art will recognize that the invention can be practiced with modification within the spirit and scope of the claims.

What is claimed is:

1. A thermostat transducer module comprising:
a processor;
at least one A/D conversion circuit interfaced to said processor; and
at least one output level conversion circuit interfaced to said processor, said processor configured to:
receive signals originating at a thermostat through said at least one A/D conversion circuit;
analyze the received signals; and
generate signals based on the analysis for output through said at least one output level conversion circuit for control of a motor.

2. A thermostat transducer module according to claim 1 wherein the signals generated by said processor include at least one of serial communications signals for motor control and pulse width modulated signals for motor control.

3. A thermostat transducer module according to claim 1 wherein said at least one A/D conversion circuit is configured to convert signals from the thermostat that are based on an approximately 24 VAC voltage source to a voltage level compatible with said processor.

4. A thermostat transducer module according to claim 1 wherein said at least one output level conversion circuit is configured to convert signals from said processor to a voltage level compatible with a motor control unit.

5. A thermostat transducer module according to claim 1 further comprising a serial interface configured to provide a communications interface between said processor and a computer.

6. A thermostat transducer module according to claim 1 wherein said processor comprises at least one of a microcontroller, a microprocessor, a programmable logic device, and a programmable gate array.

7. A thermostat transducer module according to claim 1 further comprising at least one switch interfaced to said processor and wherein the signals generated by said processor comprise pulse width modulated signals for motor control, said pulse width modulated signals comprising at least one of a programmable pulse width, a programmable slew rate, and a programmable off delay based on signals received by said module from a thermostat and settings of said at least one switch.

8. A thermostat transducer module according to claim 1 wherein said at least one output level conversion circuit is configured to receive motor speed (RPM) information from the motor and convert the information to a level compatible with said processor.

9. A thermostat transducer module according to claim 8 further comprising a serial interface, said serial interface configured to provide a communications interface from said processor to an external system, said processor configured to communicate the motor speed information to the external system.

10. A thermostat transducer module according to claim 1 further comprising a power supply configured to supply power to at least said processor, said at least one A/D conversion circuit, and said at least one output level conversion circuit, said power supply configurable to receive one or more of an approximate 24 VAC signal, a rectified 24 VAC signal, and a 24 VDC signal.

11. A thermostat transducer module according to claim 1 wherein said processor comprises a flash memory and said module comprises a serial interface, said flash memory reprogrammable through said serial interface.

12. A thermostat transducer module according to claim 1 further comprising a plurality of input and output signals interfaced to said processor, said input and output signals and said processor configured to provide at least user feedback and troubleshooting feedback.

13. A variable speed motor control system comprising:
a motor configured to receive at least one of serial communication signals, motor control signals, and pulse width modulated motor control signals;
a thermostat configured to output at least one system control signal; and
a thermostat transducer module comprising a processor, at least one A/D conversion circuit interfaced to said processor, and at least one output level conversion circuit interfaced to said processor, said thermostat transducer module configured to receive signals originating at said thermostat through said at least one A/D conversion circuit and analyze the received signals in order to generate signals for output through said at least one output level conversion circuit to provide the motor control signals to said motor.

14. A variable speed motor control system according to claim 13 wherein said thermostat transducer module is configured to receive signals from said motor representative of motor operation.

15. A variable speed motor control system according to claim 13 wherein said thermostat transducer module is configured to output at least one of serial communications signals for motor control and pulse width modulated signals for motor control.

16. A variable speed motor control system according to claim 13 wherein said at least one A/D conversion circuit is configured to convert signals received from said thermostat to a voltage level compatible with said processor.

17. A variable speed motor control system according to claim 13 wherein said at least one output level conversion circuit is configured to convert signals from said processor to a voltage level compatible with said motor.

18. A variable speed motor control system according to claim 13 wherein said thermostat transducer module comprises a serial interface configured to provide a communications interface between said thermostat transducer module and an external computer system.

19. A variable speed motor control system according to claim 13 wherein said thermostat transducer module comprises at least one switch interfaced to said processor and wherein the signals generated by said processor comprise pulse width modulated signals for motor control, said pulse width modulated signals comprising at least one of a programmable pulse width, a programmable slew rate, and a programmable off delay based on signals received by said module from a thermostat and settings of said at least one switch.

20. A variable speed motor control system according to claim 13 wherein said thermostat transducer module is configured to receive motor speed (RPM) information from said motor and convert the motor speed information to a voltage level compatible with said processor.

21. A method for controlling a motor comprising:
receiving signals from a thermostat;
interpreting the signals from the thermostat with a processor; and
outputting signals from the processor to control the motor, the signals from the processor based at least in part on the interpretation of the signals received from the thermostat.

22. A method according to claim 21 wherein interpreting the signals from the thermostat comprises converting signals received from the thermostat to a voltage level compatible with the processor.

23. A method according to claim 21 wherein outputting signals from the processor to control the motor comprises converting signals from said processor to a voltage level compatible with said motor.
